(19) United States
(12) Patent Application Publication
(10) Pub. No.: US 2012/0270094 A1
(43) Pub. Date: Oct. 25, 2012

(54) ELECTRIC ENERGY MEMORY APPARATUS WITH FLAT-TYPE CELLS, SPACING ELEMENTS AND CONTACT DEVICES

(75) Inventors: Claus-Rupert Hohenthanner, Hanau (DE); Jens Meintschel, Bernsdorf (DE); Torsten Schmidt, Landsberg (DE); Claudia Brasse, Hanau (DE)

(73) Assignee: LI-TEC BATTERY GMBH, Kamenz (DE)

(21) Appl. No.: 13/256,732

(22) PCT Filed: Mar. 15, 2010
(86) PCT No.: PCT/EP10/01620

§ 371 Date: Jul. 2, 2012

(30) Foreign Application Priority Data
Mar. 16, 2009 (DE) 10 2009 013 346.1

(51) Int. Cl. H01M 10/02; H01M 2/24

(52) U.S. Cl. 429/158; 429/156

(57) ABSTRACT

A storage device for electrical energy with a plurality of flat storage cells for the storage and the discharge of electrical energy with opposing flat-shaped conductors, spacer elements for maintaining a predetermined space between the storage cells and a clamping means for the clamping of the cells into a stack. The spacer elements have pressure surface areas, wherein the conductors of the cells, each are clamped between the pressure surface areas of two spacer elements by the clamping means by means of force closure. In the area of opposing pressure surface areas of a spacer element, either a contacting element for establishing an electrical connection between the opposing pressure surface areas or an insulating structure is provided. The spacer elements are provided such, that the compressions between the pressure surface areas with an insulating structure and between the pressure surface areas with a contacting element, are ajusted to each other.

Priority application DE 10 2009 013 346 as filed on Mar. 16, 2009 is fully incorporated by reference herein.

The present invention relates to a storage device for electrical energy with flat cells and spacer elements.

It is known in the art, to construct a storage device for electrical energy from a plurality of storage cells for electrical energy, which are assembled to a block by means of a clamping device. Such storage cells for electrical energy are, for example, so-called Pouch cells or coffee-bag cells, which are storage cells built with a flat and a rectangular shape (battery cells, accumulator cells, capacitors, . . . ), the electrochemically active part of which is surrounded by a foil-like packaging, through which electrical connections in sheet form, the so-called (current-) conductors, protrude. Electrical connection of the cells in series or in parallel, is achieved by conductive contacting elements, which establish electrical connection between the respective conductors of adjacent cells. For this it is common, to arrange the cells in a stack, loosely placed into a rack or pressed together my means of clams or the alike, and to connect the poles or, respectively, the conductors, which are exposed on the top, with appropriate means.

It is an objective of the present invention to provide a storage device for electrical energy, in which a number of flat storage cells are arranged in a space-saving and assembly-friendly manner into a stable block, in which they are securely fixed and reliably connected. In particular, it is an objective of the invention, to avoid mechanical stress on the electrochemically active parts of the storage cells. Furthermore, another objective of the invention is, to suitably distribute mechanical stress of the other components, to keep their deformation evenly, and to avoid damaging the same.

The problem is solved by the features of the independent claims. Advantageous developments of the invention are the subject-matter of the dependent claims.

According to the present invention, a storage device for electrical energy has a plurality of flat storage cells for the storage and the discharge of electrical energy with opposing flat conductors, a plurality of spacer elements for maintaining a predetermined space between the storage cells, and clamping means for clamping the cells into a stack, wherein the spacer elements have pressure surface areas and wherein the conductors of the cells each are clamped between the pressure surface areas of two spacer elements by means of force-fit of the clamping means, wherein either a contacting device for establishing an electrical connection between the opposing pressure surface areas or an insulating structure is provided in the area of opposing pressure surface areas of a spacer element, wherein the spacer elements are designed such that the compressions areas between the pressure surface areas having an insulating structure and between the pressure surface areas having a contacting device are adjusted with respect to each other.

Since the conductors of the cells are each clamped between the pressure surface areas of two spacer elements by means of force-fit of the clamping means, a predetermined spacing is maintained between adjacent cells, which can be adjusted such that no clamping force is applied to an electrochemically active part of the cells. This provides advantages with respect to the functional reliability, the durability, and the temperature balance of the cells. Since further a contacting device for electrical connection between the opposing pressure surface areas may be provided within the area of the pressure surface areas, the conductors of adjacent cells may be electrically connected without additional connectors. The contacting device having the spacer elements may be premounted they may form a spacer element; this facilitator installation. Since, furthermore, the contacting devices are, as part of the spacer elements, clamped together by means of the clamping means, and therefore, are held in place, they cannot be lost during the operation of the device or, respectively, no additional measures are required to prevent such potential loss. Since, consequently, as an alternative, an insulating structure is provided in case no contacting device between pressure surface areas is provided, any conceivable connection of the storage cells within the storage device for electrical energy may be achieved by the selective use of contacting elements or insulating structure between the conductors of adjacent storage cells. Finally, since compression effects between the pressure surface areas having support structure and between the pressure surface areas having contacting elements, are adjusted to each other, the forces which are exerted via the pressure surface areas onto the conductors, may be uptaken uniformly and distributed. Also during clamping by means of the clamping means, unilateral easing of the spacer elements and distortion of the overall structure of the stack may be avoided.

Preferably, the clamping means has a plurality, preferably four or six, anchor rods, which protrude through through-holes in the conductors. By means of such an assembly, the clamping force is concentrated where the clamping force is intended to have an effect, namely, on the conductors.

To avoid short-circuits, the anchor rods are preferably coated with an electrically insulating material, or they are enclosed by a continuous insulating sleeve.

Preferably, the contacting devices are provided as one or several contacting elements, which are incorporated into the spacer elements. Particular by preferably, one or several supporting elements is/are arranged in the area of an insulating structure, which is incorporated into the spacer elements. This allows to minimize the use of materials for the specific tasks of contacting and supporting. In addition the overall weight can be reduced by minimizing the heavy material generally used for contacting. The contacting elements are made of an electrically conductive material, and the supporting elements are made of an electrically insulating material, preferably a glass or a ceramic material.

Particularly preferrably, the frontal area of the supporting elements is at least equal in size, in particular larger in size, compared to the frontal area of the contacting elements. Thereby the pressing forces can be taken up reliably and damage to the spacer elements can be avoided.

Preferably, the contacting elements and the supporting elements are designed to be sleeve-like and are accommodated by corresponding recesses in the spacers elements, wherein the anchor rods protrude through the sleeve-like contacting and supporting elements. Alternatively, the contacting and/or supporting elements are designed to be rod-like and are incorporated in corresponding recesses in the spacer elements. Furthermore, they provided with through-holes, through which the anchor rods protrude. In another alternative embodiment, the spacer elements are completely formed as a supporting element or as a contacting element. In all cases, a particularly space-saving assembly is achieved, in which contacting and clamping is realized by means of concentrically components. In addition, the clamping force of the clamping means is concentrated onto the contacting elements, and therefore, a particularly reliable electrical contact is achieved.

Preferably, each spacer element is designed as an essentially four-sided frame, such that two parallel frame sides each have pressure bars with frontal opposing pressure surface areas. Thus, each cell is arranged in the direction of a stack between two frames and the distance of the spacer elements along the direction of the stack, is predetermined by the frame sides, which connect the pressure bars, Therefore, the stack of cells and spacer elements (i.e., frames), already stabilizes itself during the assembly.

Particularly preferrably, in each frame one of the pressure bars comprises the contacting device and the other pressure bar comprise the insulating structure. This way, by means of an alternating assembly of the frames and the storage cells, an fail-safe electrical connection in series can be realized.

Particularly preferably, the stack has two conductive, preferably frame-like, pressure end pieces, which rest on the first or, respectively, on the last spacer element in the direction of the stack, and which are clamped to the stack by means of the clamping means, and which are each electrically connected with a conductor of the first or, respectively, the last cell, by means of the contacting device in the first or, respectively, the last spacer element. Thereby, the end pieces are used as poles of the storage device for electrical energy from which the entire voltage can be used.

The invention is particular by advantageously applicable to Li-ion batteries.

The aforementioned and additional features objectives, and advantages of the present invention will become more apparent from the following description, which was made with reference to the accompanying figures.

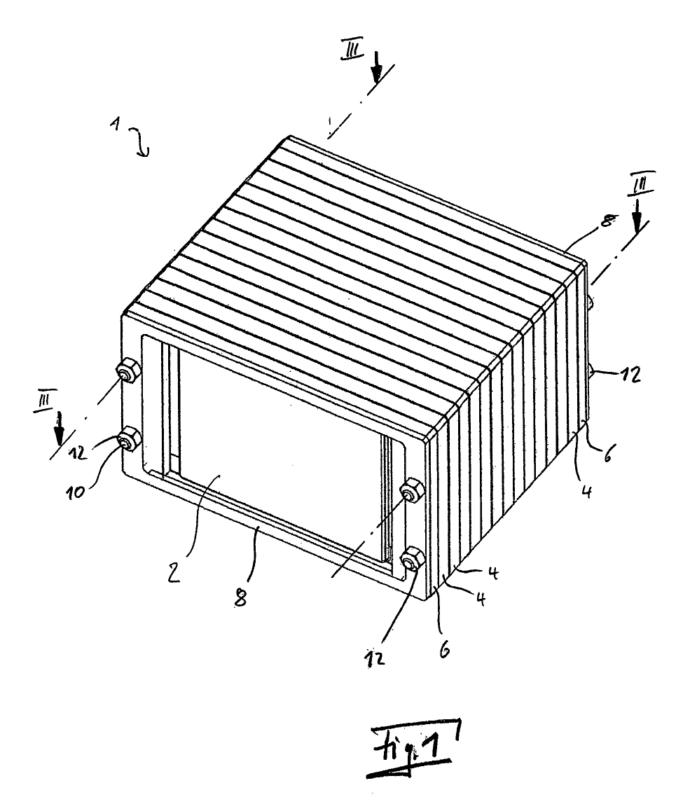

FIG. 1 is a perspective view of a cell block of a first embodiment of the present invention in an assembled state;

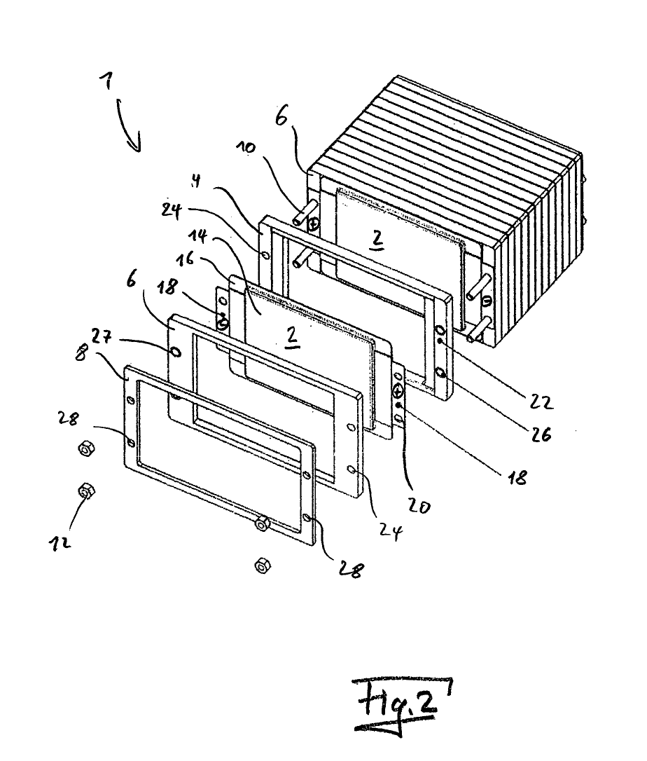

FIG. 2 is a perspective exploded view of the cell block of FIG. 1, in a partially assembled state;

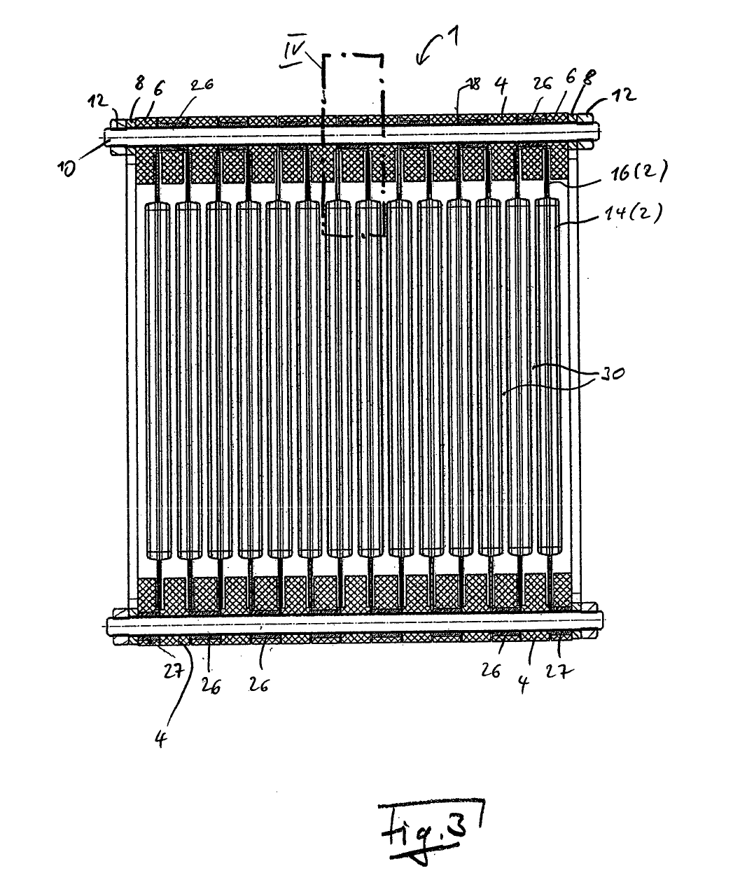

FIG. 3 is a frontal view of the cell block of FIG. 1 in a horizontal longitudinal section;

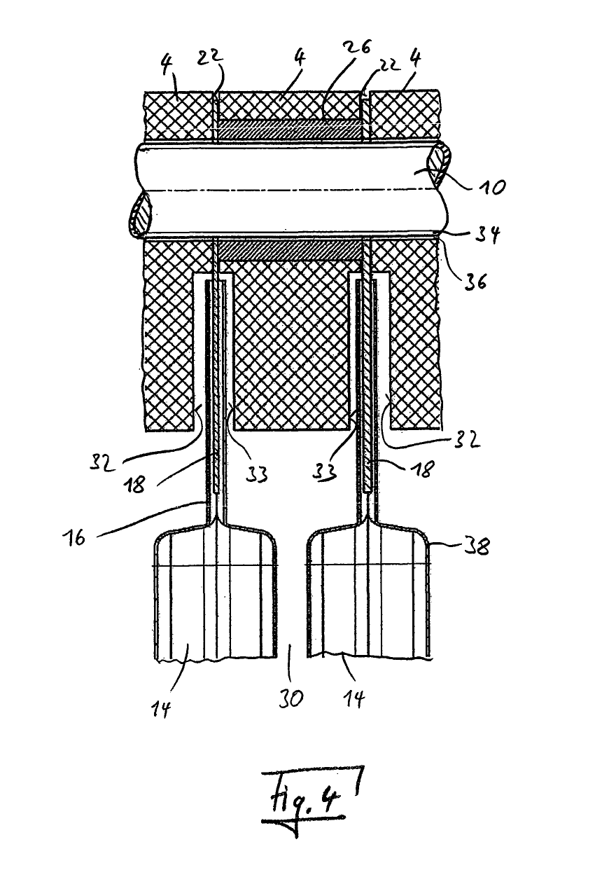

FIG. 4 is an enlarged view of a detail “IV” of FIG. 3;

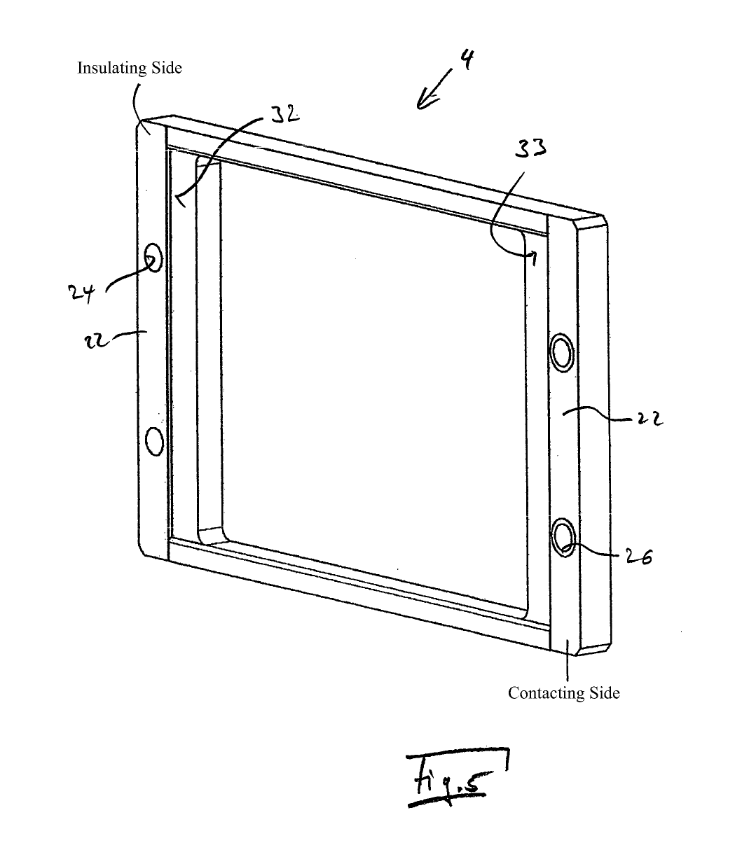

FIG. 5 shows a frame of the cell block of FIG. 1 with integrated contacting sleeves;

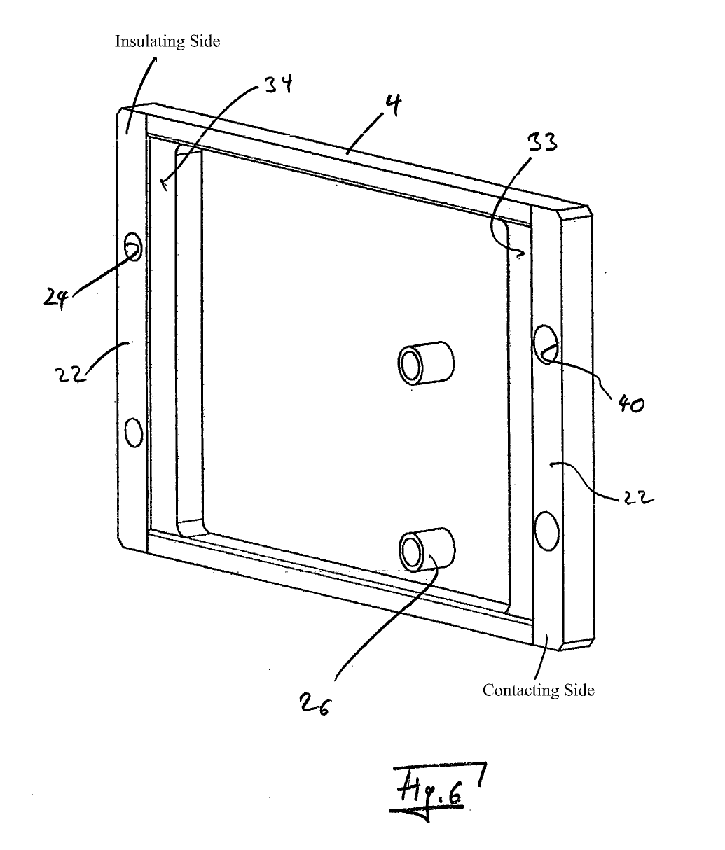

FIG. 6 shows the frame of FIG. 5 with contacting sleeves in an exploded view;

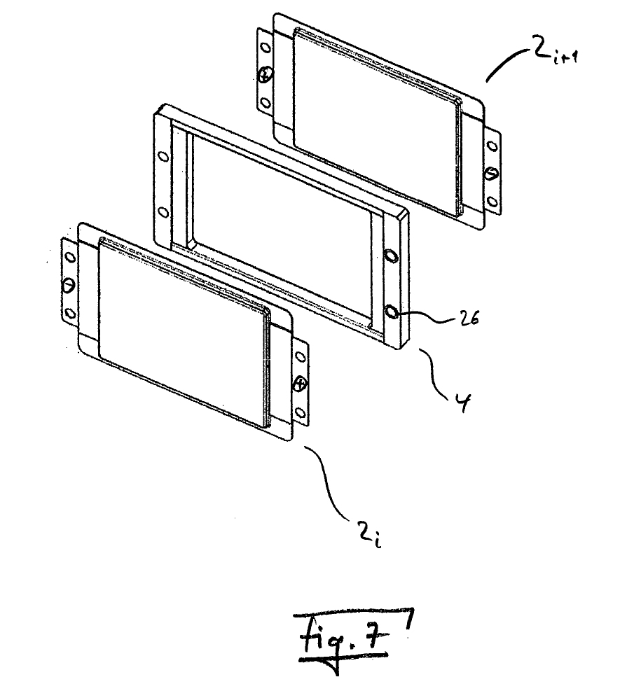

FIG. 7 shows the frame of FIG. 5 with two adjacent Pouch cells;

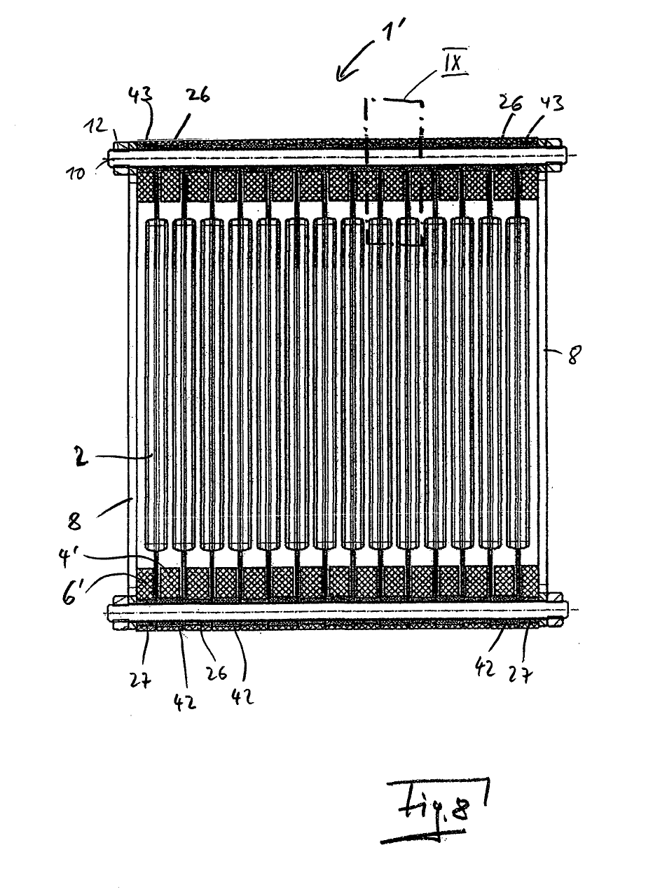

FIG. 8 shows a cell block of a second embodiment of the present invention in a sectioned frontal view, wherein the sectional direction is identical to the one in FIG. 3;

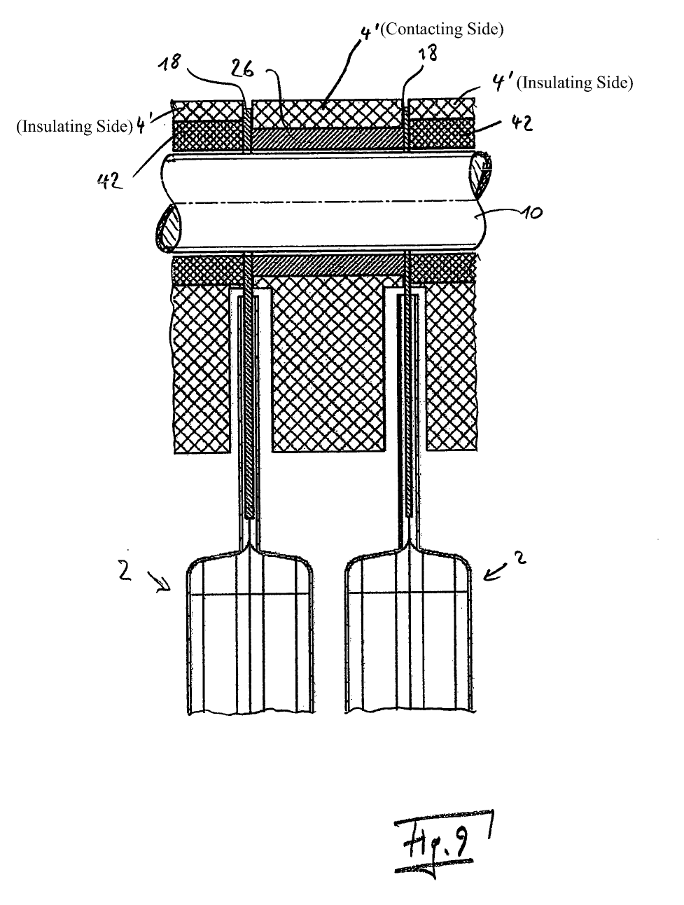

FIG. 9 is an enlarged view of a detail “IX” of FIG. 8;

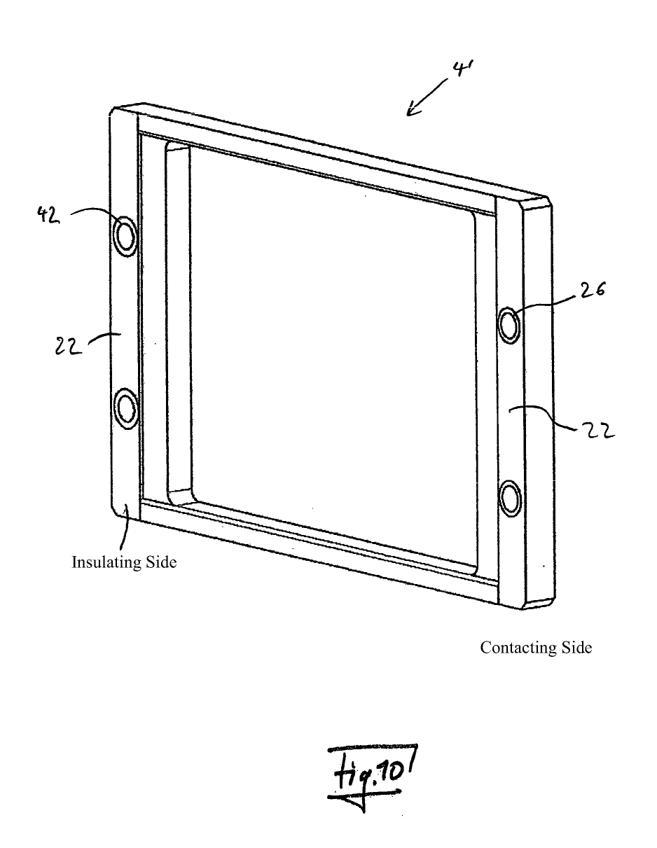

FIG. 10 shows a frame of the cell block of FIG. 8 with integrated contacting and supporting sleeves, wherein the view is identical to the view in FIG. 5;

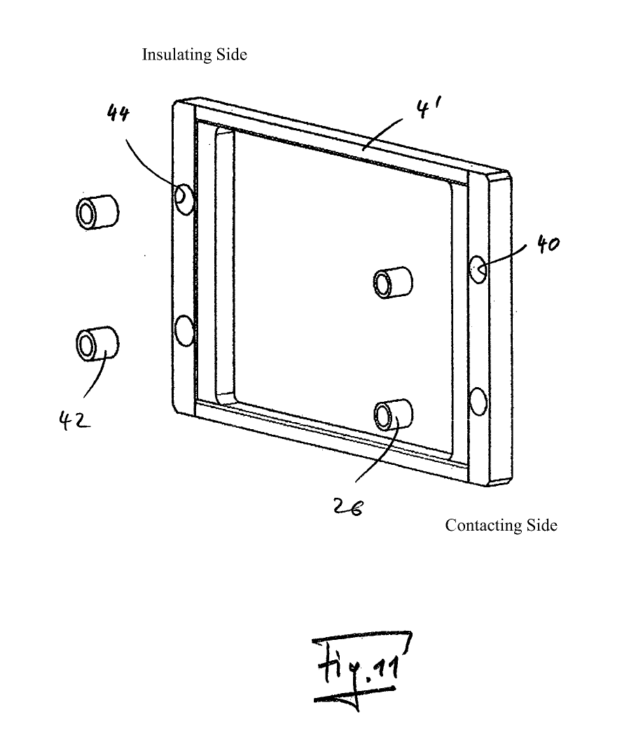

FIG. 11 shows the frame of FIG. 10 with contacting and supporting sleeves in an exploded view; and

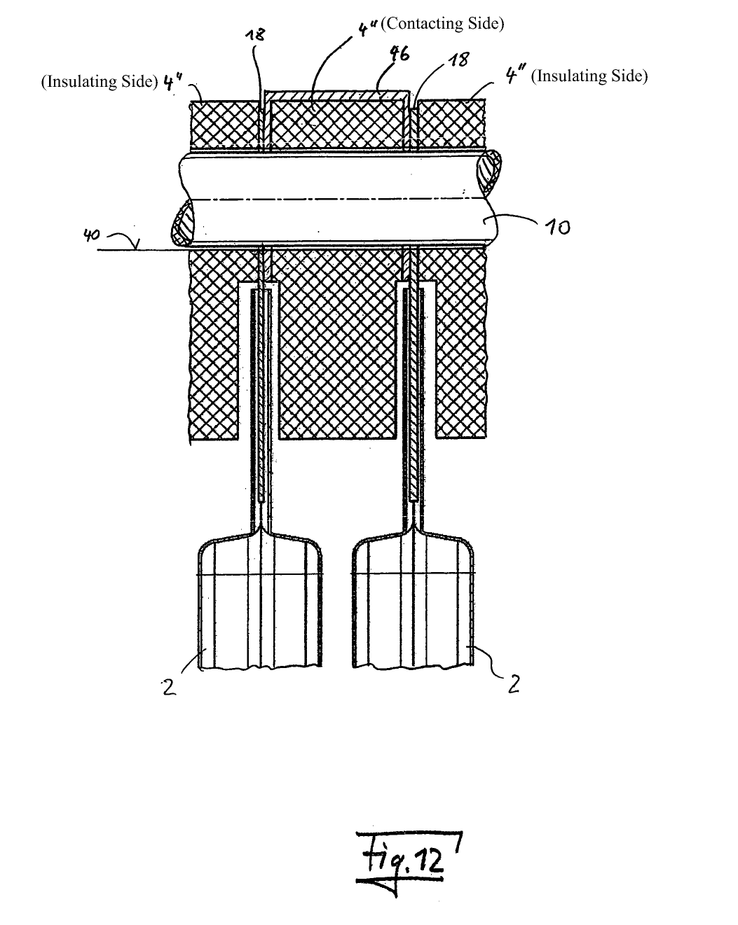

FIG. 12 shows a contacting area in a cell block of a third embodiment in a view corresponding to the view in FIG. 4.

It should be noted that the illustrations in the figures are schematically, and that they are reduced to the features, which are most important for the understanding of the invention. It is also to be noted, that the dimensions and proportions of the figures are solely provided for clarity of the illustrations, and that by no means, these are to be understood in a limiting way.

A first embodiment of the present invention will now be described with reference to FIGS. 1 to 7. Therein, FIG. 1 is a perspective view of a cell block 1 of a first embodiment of the present invention, in an assembled state; FIG. 2 is a perspective exploded view of the cell block 1 in a partially assembled state; FIG. 3 is a frontal view of the cell block 1 in the horizontal longitudinal section in a plane “III” of FIG. 1; FIG. 4 shows a frame of the cell block 1 with integrated contacting sleeves; FIG. 5 shows the frame of FIG. 4 with contacting sleeves in an exploded view; FIG. 6 is an enlarged view of a detail “VI” of FIG. 3; and FIG. 7 shows the frame of FIG. 4 with two adjacent pouch cells.

According to the perspective overall view of FIG. 1, the cell block 1 has a plurality of storage cells 2 (galvanic cells, accumulator cells or the like, in FIG. 1, only one cell is visible), a plurality of intermediate frames 4, two end frames 6, two pressure frames 8, as well as four anchor rods 10 with nuts 12, which are mounted on both sides. One of the two end frames 4, the in-between frames 6 and the second of the two end frames 4, form a stack, which is held together by pressure frames 8, which are arranged on their ends, and by means of anchor rods 10 and the nuts 12. Storage cells 2 are within the structure, which is formed by the stacked frames 4, 6, as will be described in detail, below.

In FIG. 2, the cell block 1 of FIG. 1 is shown in a perspective partially exploded view. i.e. nuts 12 are removed. On the side facing the viewer, pressure frame 8, end frame 4, a storage cell 2 and an intermediate frame 6 are all removed from the anchor rods 10.

As shown in FIG. 2, storage cells 2 are designed as so-called flat cells or pouch cells with opposing, flat conductors. More specifically, each storage cell 2 has an active part 14, a sealing seam (a border area) 16 and two conductors 18. In the active part 14, the electrochemical reactions for storage and discharge of electrical energy take place. Generally, any type of electrochemical reaction may be used for the construction of storage cells; the description however, refers in particular to Li-ion batteries, to which the invention is particularly applicable due to the demands on mechanical stability and thermal balance, as well as due to the economic significance. The active part 14 is sandwiched by two foils, wherein the protruding edges of the foil are welded together in a gas- and liquid-tight manner and thereby form the so-called sealing seam 16. A positive or, respectively, a negative conductor (cell pole) 18 protrudes from the two opposing short sides of the storage cell 2. Two through-holes 20 (hereinafter referred to as pole through-holes) are present in each of the conductors 18.

Storage cells 2 are placed onto the anchor rods 10 the pole through-holes 20, and in a way so that a storage cell 2 is either arranged between two intermediate frames 4 or between an intermediate frame 4 and an end frame 6. Frames 4, 6 are constructed such that the active part 14 of the storage cells 2 is arranged within the cavity of frame 4, 6, while pressure surface areas 22 press against the flat sides of the conductors 18, and further hold the same in position, after tightening the anchor rods 10 and the nuts 12. The sides of the frames 4, 6 are also refered to as pressure bars.

Frames 4, 6 further have, through-holes 24 and contacting sleeves 26, 27 in their pressure surface areas 22. More specifically, contacting sleeves 26 are provided the intermediate frames 4, and contacting sleeves 27 are provided in the end frames 6, which only differ from each other by length since intermediate frames 4 are thicker than end frames 6 (see below). Therein through-holes 24 are provided on the one lateral side of a frame 4, 6, while the contacting sleeves 26, 27 are provided in larger through-holes on the other lateral side of the corresponding frame 4, 6. Through-holes 24 and contacting sleeves 26, 27 are aligned with the pole through-holes 20 in the conductors 18 of the storage cells 2. Thus, also frames 4, 6 with their through-holes 24 and their contacting sleeves 26, 27 are placed over the anchor rods 10. In case of an intermediate frame 4, contacting sleeves 26 provide electrical contact between the conductors 18 of the storage cells, which are arranged on both sides, whereas in the case of an end frame 6, contacting sleeves 27 provide an electrical contact between a conductor 18 of a storage cell 2 and one of pressure frames 8. On the other lateral side, on which no contacting sleeves are arranged, frame 4, 6 forms an electrical insulation between the conductors 18 of two storage cells 2 or, respectively, conductor 18 and pressure frame 8.

Frames 4, 6 are arranged within cell block 2 such, that the through-holes 24 and the contacting sleeves 26, 27 alternate with the sequence of frames 4, 6. In other words, on each lateral side of the cell block 1, a pressure bar with a through-hole 24 is always followed by a pressure bar with a contacting sleeve 26 or 27, and vice versa. Furthermore, storage cells 2 are arranged within the cell block in two alternate directions, i.e., on a lateral side, a conductor 18 with positive polarity is always followed by a conductor 18 with a negative polarity, and vice versa. As described above, conductors 18 of two storage cells 2, which are spaced by an intermediate frame 4 are connected with each other on one lateral side by contacting sleeves 26, while conductors 18 on the other lateral side are electrically separated from each other by the electrically insulating material of the intermediate frame 4. Thereby all storage cells 2 within the cell block 1 are connected with each other “plus-on-minus”, i.e., an electrical connection of the storage cells 2 in series is implemented in the cell block 1. In addition, conductor 18 of the first and of the last storage cell 2, which is not connected with another storage cell 2, is connected in cell block 1 with the respective pressure frame 8 such, that the respective pressure frames 8 form a positive and a negative pole, on which the voltage of the entire cell block 1 is applied.

As described above, frames 4, 6, are made of a low-cost, electrically insulating material, such as, for example, plastic, which can be solid or fiber-reinforced. In contrast, the contacting sleeves 26, 27 are made of an electrically conductive material such as, for example, copper or brass, bronze, or another copper alloy, or another metal, or another metal alloy, with or without a coating that enhances the conductivity as, for example, silver or gold.

On the back side of conductors 18, contacting sleeves 26, 27 are supported against the material of the frames 4, 6. In case the material of the frames 4, 6 is more resilient than the material of the contacting sleeves 26, 27, in order to avoid unequal compression of the frames 4, 6 on both lateral sides, appropriate measures should be taken to ensure that the yield of the frame 4, 6 on the side without a contacting sleeve (insulating side), equals the total yield of frame material and sleeve material, on the side with the contacting sleeves 26, 27 (contacting side). Appropriate measures to adjust the overall compression or, respectively, the rigidity on both lateral sides of the frame 4, 6 to each other, are:
an increased fiber content on the insulating side in case of a fiber-reinforced plastic;
different material or raw material compositions on the insulating and on the contacting side;
reinforced inserts on the insulating side;
larger bar width, at least a supporting bar width on the insulating side.

These measures can be implemented individually or in combination to achieve the desired result.

In FIG. 3, which shows a horizontal, longitudinal, sectional view of cell block 1 in a plane III of FIG. 1, the alternating assembly of contacting sleeves 26 in intermediate frames 4, and contacting sleeves 27 in end frames 6, is easily recognized. Similarly, the assembly of intermediate frames 4 and of end frames 6 can be seen. Frames 4, 6 are designed such that the pressure surface areas (22, not further denoted in the figure) press on the opposite flat sides of the conductors 18 of the storage cells 2. They also are of a thickness such that an air gap 30 is formed between the active part 14 of the storage cells 2. On the one hand, this air gap 30 keeps mechanical pressure loads off the active parts 14, so that defects of the electrochemical function, which relate to mechanical pressure loads, can be avoided. On the other hand, cooling of the storage cells 2 is possible via air gap 30.

As can be seen in FIG. 3, end frames 6 have a smaller thickness than intermediate frames 4. This takes into account the fact that a storage cell is arranged, only on one side of the end frame 6. Accordingly, contacting sleeves 27 which are arranged within end frames 6 are also shorter than contacting sleeves 26, which are arranged within intermediate frames 4.

FIG. 4 shows the contacting area between two storage cells 2 as a detail “IV” of FIG. 3. The air gap 30 between the active parts 14 of the storage cells 2 is also clearly visible. By means of cutouts 32, 33 within pressure areas 22 of the intermediate frames 4, it is ensured that the pressure areas 22 only exert pressure on conductor 18, but not on the other edge areas of the storage cells 2 having sealing seam 16. Cutouts 32 on the insulating side are deeper than on the contacting side. In contrast to the intermediate frames 4, and frames 6 have cutouts 32, 33 only on one flat side.

Anchor rod 10 has a continuous sleeve 34 of an insulating material. In addition a space 36 is provided, between anchor rod 10 and the components, which are protruded by the anchor rod 10. Thereby anchor rod 10 is electrically insulated vis-a-vis the conducting or, respectively, live parts, i.e., conductors 18, pressure frames 8 and contacting sleeves 26, 27, and a short circuit is effectively prevented. Although not further illustrated in the figure, frames 4, 6, pressure frames 8, and storage cells 2 are held radially centered, such that the space 36 between the anchor rods 10 and the conducting or, respectively, live parts 18, 26, 27, 8 is always maintained; appropriate means for centering are, for example, dowel pins, or an, accordingly, geometrically tailored shape of the stacked components. Also, an appropriate insulation of the nuts 12 towards the pressure frames 8 is provided, which, as well, is not further illustrated in the figures. This insulation can, for example, be provided by means of insulating discs or bushings collars, whose respective cylinder part projects into the respective pressure frame 8.

With respect to the assembly of the storage cell 2, FIG. 4 shows that the conductors 18 of the plus and minus sides may have different thicknesses. Also, foils 38 for the packaging of the active part 14 of the storage cells 2, can be discerned.

FIG. 5 shows an individual intermediate frame 4, in a perspective view with pressure surface areas 22, through-holes 24, and cutout 33 on the insulating side, as well as contacting sleeves 26 and cutout 33 on the contacting side.

FIG. 6 corresponds to FIG. 5 with the difference, that the contacting sleeves 26 are removed and are displayed separately. Thus, the through-holes 40 in the pressure surface areas 22 of the contacting sides become visible. Said through-holes are provided for the insertion of contacting sleeve 26.

For clarification, FIG. 7 shows again the sequence of a storage cell 2ᵢ with a minus pole on the left side of the drawing, and a plus pole on the right side of the drawing, of an intermediate frame 4 with the contacting sleeves 26, and a storage cell 2ᵢ₊₁ with a minus pole on the right side of the drawing and a plus pole on the left side of drawing. The plus pole of the storage cell 2ᵢ is connected to the minus pole of the storage cell 2ᵢ₊₁ via the contacting sleeves 26.

Now a second embodiment of the present invention will be described, based on FIGS. 8 to 11. FIG. 8 is a top view of a cell block 1′ of the embodiment of FIG. 1 in the horizontal, longitudinal section corresponding to FIG. 3; FIG. 9 is an enlarged view of a detail “IX” of FIG. 8; FIG. 10 shows a frame of the cell block of FIG. 1 with integrated contacting and supporting sleeves. FIG. 11 shows in an exploded view, the frame of FIG. 10 with contacting sleeves and with supporting sleeves.

In this embodiment, cell block 1′ is essentially the same cell block 1 as in the first embodiment, and the explanations given above are applicable to this embodiment, unless stated to the contrary in the explanations discussed below. The differences of the cell blocks primarily relate to the intermediate frames 4′ and to the end frames 6′, which differ slightly from the intermediate frames 4 and the end frames 6 of the first embodiment.

In contrast to cell block 1 of the first embodiment, intermediate frames 4′ in this embodiment have, in addition to contacting sleeves 26, which are arranged on the contacting side, also supporting sleeves 42, which are arranged on the insulating side. The end frames 6′ in this embodiment have correspondingly, supporting sleeves 43, which are arranged on the insulating side, in addition to the contacting sleeves 27. The supporting sleeves 42, 43 are made of a material, which has a yield or rigidity, corresponding to the contacting sleeves 26, 27. Therefore, contacting sleeves 26, 27, which rest on the conductors 18 of the storage cells 2, can effectively be supported by the supporting sleeves, which rest on the back side of the conductors 18. A one-sided compression of the frames 4′, 6′ is therefore, avoided, as is a sinking of the contacting sleeves 26, 27 and a deformation of the conductor 18 caused by this.

FIG. 9 shows as a detail “IX” of FIG. 8, the configuration of the electrical connection of the conductors 18 of two storage cells 2 through a contacting sleeve 26 with supporting sleeves 42 as a counter bearing, illustrated therein in enlarged form. It is clearly visible in the figure that the supporting sleeves 42 have a larger outside diameter than the contacting sleeves 26, in order to develop a particularly effective supporting action. Supporting sleeves 26 are made of a hard, electrically insulating material such as, for example, a glass or a ceramic material, or a hard, possibly, fiber-reinforced plastic. The examples as outlined above correspondingly apply to the supporting sleeves 43, which are arranged in the end frames 6′.

FIG. 10 shows a single intermediate frame 4′ in a perspective view, with the pressure surface areas 22, the supporting sleeves 42 on the insulating side, and the contacting sleeves 26 on the contacting side.

FIG. 11 corresponds to FIG. 10 with the difference, that the contacting sleeves 26 and the supporting sleeves 42 are removed and are shown individually. Thereby, the through-holes 40 in the pressure surface areas 22 of the contacting side and the through-holes 44 in the pressure surface areas 22 of the insulating side become visible, wherein said through-holes are provided to accommodate the contacting sleeves 42 or, respectively, the supporting sleeves 42.

FIG. 12 shows a contacting area between the conductors 18 of two adjacent storage cells 2 in a cell block of a third embodiment. The section of the drawing corresponds to the one of FIG. 3.

The cell block in this embodiment corresponds essentially to the cell block 1 in the first embodiment, and the explanations given above, are also applicable to this embodiment, unless discussed to the contrary the explanations given below. The differences essentially relate to the intermediate frames 4″ and to the end frames (not further illustrated in the figure), which differ slightly from the intermediate frames 4 and the end frames 6 of the first embodiment.

According to the illustration in FIG. 12, a contact spring 46 is provided on the contacting side of the intermediate frame 4″, wherein said contact spring 46 establishes a contact between the conductors 18 of two adjacent storage cells 2. The contact spring 46 is made of a well-conducting material (see above) and has a profile in a U-shape. The contact spring 46 is attached from the outside to the pressure surface area (22, not further specified in the figure) of the intermediate frame 4″. The intermediate frame 4″ has a smaller thickness on the contacting side than on the insulating side, and the inside width of the U-shape profile of the contact spring 46 corresponds to the thickness of the intermediate frame 4″ in this position. The outside width of the U-shape profile of the contact spring 46 corresponds to the thickness of the intermediate frame 4″ on the insulating side. The contact spring 46 has through-holes in its extending arms, which align with the through-holes 40 in the pressure surface areas 22 of the intermediate frame 4″ and which have the same diameter. In contrast to the intermediate frames 4 of the first embodiment, the intermediate frames 4″ in the present embodiment have through-holes 40 with the same diameter, both on the insulating side, as well as on the contacting side, since no contacting sleeve are provided on the contacting side.

The above given explanations apply equally to the end frames, which are not further illustrated for this embodiment. Therein, contact springs with a smaller width are to be used, corresponding to the smaller thickness of the end frame.

Contact springs 46 provide no significant resistance against the pressure, applied by the anchor rods, so that no asymmetrical compressions arise on the contacting side and on the insulating side. The contact springs 46 extend over the entire height of the pressure bar of the frames on the contacting side, so that, also, no identation of the pressure surface area 22 has to be expected.

In a variation of the third embodiment not further illustrated, the width of the intermediate frame 4″ on the contacting side is reduced by at least the thickness of the contact spring 4″ and the extending arms of the contact spring have, correspondingly, a smaller height. Thus, no parts, which conduct current or which are live an electrical potential, i.e. are on, protrude on the side of the cell block.

In another variation, contact springs 46 are provided with an insulating coating on the surface area, which is exposed on the lateral side, or, alternatively, an insulating cover is there provided.

Although the present invention has been described above with its essential features and with reference to specific examples, it is evident, that the invention is not limited to these examples but, that can be modified within the given scope and range provided by the claims.

In a variation, bar-shaped spacer elements (spacer or mounting bolts) are used instead of the above-described end frames and intermediate frames, each, corresponding to an insulating side or to a contacting side of the above described frames. The bar-shaped spacers elements have through-holes and sleeves, as described above, and are placed as the frames on one lateral side of the cell block, alternating with the conductors of the storage cells, onto the anchor rods. Since the anchor rods are held in their radial position by the pressure frames, a rigid and stable block is formed via the clamping with the pressure frames, which, due to the reduced material use, is lighter, than a cell block with a frame. If necessary, the pressure frames may be thicker than in the above described examples, or they may comprise stiffeners. Instead of sleeves or contact springs, the bar-shaped spacers elements may be entirely, and selectively made of a conductive material or of an electrically insulating material, wherein a material is selected for use as an insulating bar-shaped spacers element such that the material has a pressure yield adapted to the pressure yield of the conductive material.

In a further variation, bar-shaped spacer elements are held, as described above, in corresponding recesses of the frames 4, 6.

In a further variation, three or more anchor rods are used on each side.

In a final variation, instead of anchor rods, a clamping band is used for the clamping of the cell block.

### LIST OF REFERENCE NUMERALS

1, 1′ cell block
2 storage cell
4,4′,4″ intermediate frame
6, 6′ end frame
8 pressure frame
10 anchor rod
12 nut
14 active part of 2
16 sealing seam of 2
18 conductor of 2 (+or −)
20 pole through-hole in 18
22 pressure area of 4, 4′, 6, 6′
24 through-hole in 22
26, 27 contacting sleeve
28 through-hole in 8
30 air gap
32, 33 cutout in 22
34 coating or sleeve of 10
36 spacing
38 foil of 2
40 through-hole in 22
42, 43 supporting sleeve
44 through-hole in 22
46 contact spring

It is explicitly noted that the above list of reference numerals is an integral part of the description.

1. A storage device for electrical energy comprising:
a plurality of flat storage cells for the storage and the discharge of electrical energy with opposing flat conductors, a plurality of spacer elements for maintaining a predetermined space between the storage cells, and
clamping means for clamping the cells into a stack,
wherein the spacer elements have pressure surface areas, wherein the conductors of the cells, respectively, are clamped between the pressure surface areas of two spacer elements by means of force-fit of the clamping means,
wherein either a contacting device for establishing electrical contact between the opposing pressure surface areas or an insulating structure is provided in the area of opposing pressure surface areas of a spacer element, and
wherein the spacer elements are designed such that the compression areas between the pressure surface areas with an insulating structure and between the pressure surface areas having a contacting device, are adjusted with respect to each other.

2. The storage device for electrical energy according to claim 1, wherein the clamping means has a plurality of anchor rods, which protrude through through-holes in the conductors.

3. The storage device for electrical energy according to claim 2, wherein the anchor rods are enclosed by an electrically-insulating material or are surrounded by a continuous insulating sleeve.

4. The storage device for electrical energy according to claim 3 wherein the contacting devices are provided as one or several contacting elements, which are accomodated by the spacer elements, wherein the contacting elements are made of a conducting material.

5. The storage device for electrical energy according to claim 4, wherein, one or several supporting element(s) are arranged within the area of an insulating structure, which are accomodated by the spacer element, wherein the one or the several supporting element(s) are made of an electrically insulating material.

6. The storage device for electrical energy according to claim 5, wherein the front surface area of the supporting elements is at least equal in size in particular, larger in size, than the front surface area of the contacting elements.

7. The storage device for electrical energy according to claim 6, wherein the contacting elements and the supporting elements are designed to be sleeve-like, and are accommodated by corresponding recesses within the spacer elements, wherein the anchor rods protrude through the sleeve-like contacting and supporting elements.

8. The storage device for electrical energy according to claim 6, wherein the contacting or supporting elements are designed to be rod-like and are accommodated by corresponding recesses within the spacer elements, and are further provided with through-holes, through which anchor rods protrude.

9. The storage device for electrical energy according to claim 6, wherein the spacer elements are configured entirely as a supporting element or as a contacting element.

10. The storage device for electrical energy according to claim 9, wherein each spacer element is configured as an essentially four-sided frame, such that each of two parallel frame sides comprise pressure bars, with frontally opposing pressure surface areas.

11. The storage device for electrical energy according to claim 10, wherein in each frame, one of the pressure bars comprises the contacting device and the other pressure bar comprises the insulating structure.

12. The storage device for electrical energy according to claim 11, wherein the stack has two conductive pressure end-pieces, which rest on the first or, respectively, on the last spacer element, in the direction of the stack, and which are clamped together with the stack by means of the clamping means, and which are each electrically connected to a conductor of the first or, respectively, of the last cell, by means of the contacting device in the first or, respectively, in the last spacer element.

13. The storage device for electrical energy according to claim 12 wherein the storage cells are accumulators, in which an electrochemical reaction occurs, which, in the presence of Li-ions.
